(19) United States
(12) Patent Application Publication
(10) Pub. No.: US 2024/0280402 A1
(43) Pub. Date: Aug. 22, 2024

(54) INFORMATION PROCESSING DEVICE, INFORMATION PROCESSING METHOD, COMPUTER-READABLE MEDIUM, AND INSPECTION SYSTEM

(71) Applicant: NEC Corporation, Minato-ku, Tokyo (JP)

(72) Inventor: Akira Tsuji, Tokyo (JP)

(73) Assignee: NEC Corporation, Minato-ku, Tokyo (JP)

(21) Appl. No.: 18/293,810

(22) PCT Filed: Aug. 18, 2021
(86) PCT No.: PCT/JP2021/030139

§ 371 Date: Jan. 31, 2024

(51) Int. Cl. G01H 9/00

(52) U.S. Cl. CPC G01H 9/004

(57) ABSTRACT

An information processing apparatus (10) includes: acquisition means (11) for acquiring information indicating a first point, information indicating a second point, first measurement data measured at the first point, and second measurement data measured at the second point; control means (12) for determining equipment to be inspected on the basis of the data acquired by the acquisition means; and output means (13) for outputting information based on the equipment determined by the control means.

### TECHNICAL FIELD

The present disclosure relates to an information processing apparatus, an information processing method, a non-transitory computer readable medium storing a program, and an inspection system.

### BACKGROUND ART

A technique for detecting abnormalities of various equipment using a sensor such as an optical fiber sensor is known (see, for example, Patent Literature 1).

### CITATION LIST

### Patent Literature

Patent Literature 1: International Patent Publication No. WO2021/059477

### SUMMARY OF INVENTION

### Technical Problem

However, the technique described in Patent Literature 1 has a problem in that, for example, there is a case where equipment in which an abnormality has occurred cannot be appropriately specified.

In view of the above-described problem, an object of the present disclosure is to provide an information processing apparatus, an information processing method, a non-transitory computer readable medium storing a program, and an inspection system capable of appropriately specifying equipment in which an abnormality has occurred.

### Solution to Problem

In a first aspect according to the present disclosure, an information processing apparatus includes: acquisition means for acquiring information indicating a first point, information indicating a second point, first measurement data measured at the first point, and second measurement data measured at the second point: control means for determining equipment to be inspected on the basis of the data acquired by the acquisition means; and output means for outputting information based on the equipment determined by the control means.

In a second aspect according to the present disclosure, provided is an information processing method that includes: acquiring information indicating a first point, information indicating a second point, first measurement data measured at the first point, and second measurement data measured at the second point: determining equipment to be inspected on the basis of the acquired data; and outputting information based on the determined equipment.

In a third aspect according to the present disclosure, provided is a non-transitory computer readable medium storing a program for causing a computer to execute processing, the processing including: acquiring information indicating a first point, information indicating a second point, first measurement data measured at the first point, and second measurement data measured at the second point: determining equipment to be inspected on the basis of the acquired data; and outputting information based on the determined equipment.

In a fourth aspect according to the present disclosure, provided is an inspection system including an optical fiber sensor, an information processing apparatus, and an inspection apparatus that autonomously moves. In this inspection system, the information processing apparatus includes: acquisition means for acquiring information indicating a first point, information indicating a second point, first measurement data measured at the first point by the optical fiber sensor, and second measurement data measured at the second point: control means for determining equipment to be inspected on the basis of the data acquired by the acquisition means; and output means for transmitting a command for instructing an inspection of the equipment determined by the control means to the inspection apparatus that autonomously moves.

### Advantageous Effects of Invention

According to one aspect, the equipment in which an abnormality has occurred can be appropriately specified.

### BRIEF DESCRIPTION OF DRAWINGS

FIG. 1 is a diagram illustrating an example of a configuration of an information processing apparatus that executes generation processing according to an example embodiment.

FIG. 2 is a diagram illustrating a configuration example of an inspection system according to the example embodiment.

FIG. 3 is a diagram illustrating a hardware configuration example of the information processing apparatus according to the example embodiment.

FIG. 4 is a flowchart illustrating an example of processing of the information processing apparatus according to the example embodiment.

FIG. 5 is a diagram illustrating an example of an equipment DB according to the example embodiment.

FIG. 6 is a diagram illustrating an example of a type DB according to the example embodiment.

### EXAMPLE EMBODIMENT

The principles of the present disclosure will be described with reference to several exemplary example embodiments. It is to be understood that these example embodiments have been described for purposes of illustration only and will aid those skilled in the art in understanding and carrying out the present disclosure without suggesting limitations on the scope of the present disclosure. The disclosure described in the present specification is implemented in various methods other than those described below.

In the following description and claims, unless defined otherwise, all technical and scientific terms used in the present specification have the same meaning as commonly understood by those skilled in the art of the technical field to which the present disclosure belongs.

Hereinafter, example embodiments of the present disclosure will be described with reference to the drawings.

### First Example Embodiment

### <Configuration>

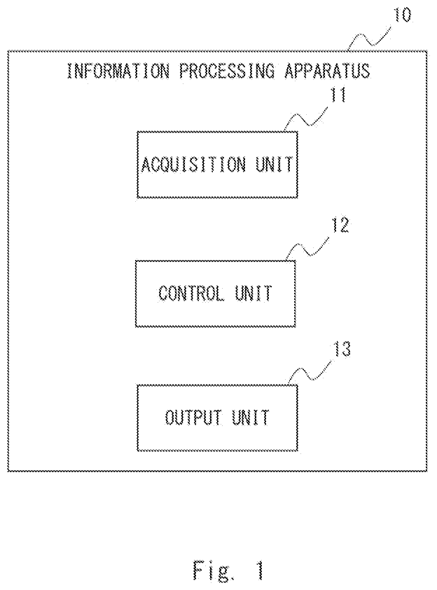

A configuration of an information processing apparatus 10 according to an example embodiment will be described with reference to FIG. 1. FIG. 1 is a diagram illustrating an example of the configuration of the information processing apparatus 10 according to the example embodiment. The information processing apparatus 10 includes an acquisition unit 11, a control unit 12, and an output unit 13. These units may be implemented by cooperation of one or more programs installed in the information processing apparatus 10 and hardware such as a processor 101 and a memory 102 of the information processing apparatus 10.

The acquisition unit 11 acquires various types of information from a storage unit in the information processing apparatus 10 or an external apparatus. The acquisition unit 11 acquires, for example, information indicating a first point, information indicating a second point, first measurement data measured at the first point, and second measurement data measured at the second point.

The control unit 12 determines equipment to be inspected on the basis of the data acquired by the acquisition unit 11. The output unit 13 outputs information based on the equipment determined by the control unit 12.

### Second Example Embodiment

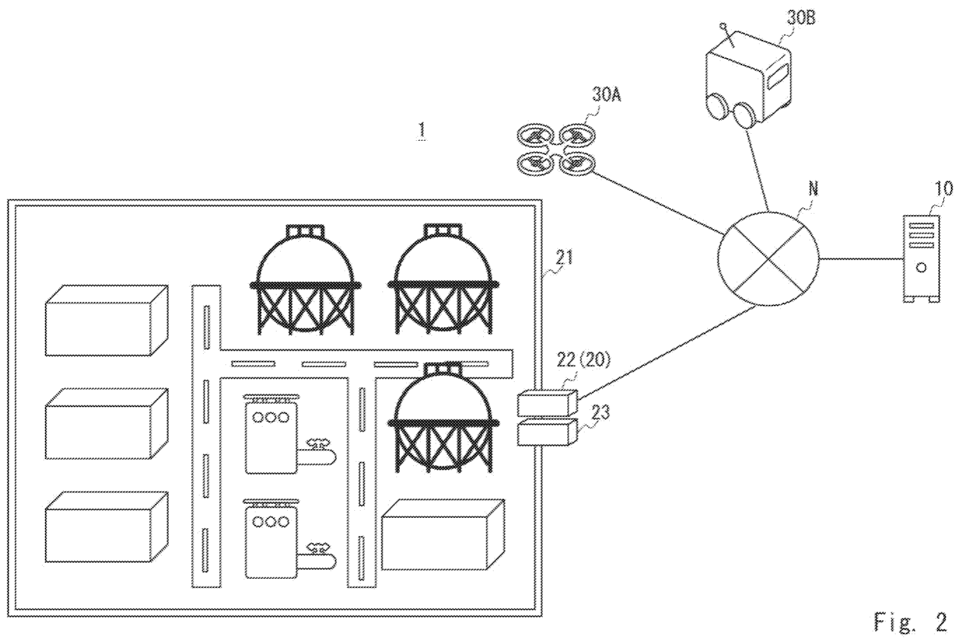

Next, a configuration of an inspection system 1 according to the example embodiment will be described with reference to FIG. 2.

### <System Configuration>

FIG. 2 is a diagram illustrating a configuration example of the inspection system 1 according to the example embodiment. In the example of FIG. 2, the inspection system 1 includes an information processing apparatus 10 and an optical fiber sensor 20. In addition, the inspection system 1 includes an inspection apparatus 30A and an inspection apparatus 30B (hereinafter, also simply referred to as “inspection apparatus 30” in a case where there is no need to distinguish them). Note that the numbers of the information processing apparatuses 10, the optical fiber sensors 20, and the inspection apparatuses 30 are not limited to the example of FIG. 2. Note that the technology of the present disclosure can be used, for example, for inspection (maintenance) of various facilities such as a substation, a plant, a factory, an office, and a distribution warehouse.

In the example of FIG. 2, the information processing apparatus 10, the optical fiber sensor 20, and the inspection apparatus 30 are connected so as to be able to communicate via a network N. Examples of the network N include the Internet, a mobile communication system, a wireless local area network (LAN), short-range wireless communication such as Bluetooth Low Energy (BLE), a LAN, a bus, and the like. Examples of the mobile communication system include a fifth generation mobile communication system (5G), a fourth generation mobile communication system (4G), a third generation mobile communication system (3G), and the like.

The information processing apparatus 10 may be, for example, an apparatus such as a server, a cloud, a personal computer, or a smartphone. The information processing apparatus 10 provides abnormality detection of various equipment installed in a facility and various services using the inspection apparatus 30. For example, the information processing apparatus 10 causes the inspection apparatus 30 to inspect equipment in which an abnormality has occurred.

In the example of FIG. 2, an optical fiber cable of the optical fiber sensor 20 is laid along the outer periphery of the site of the facility. Note that the laying position of the optical fiber cable of the optical fiber sensor 20 is not limited to the example of FIG. 2.

The optical fiber sensor 20 includes an optical fiber cable 21, which is an information transmission medium. In addition, the optical fiber sensor 20 includes a sensing device 22 connected to one end of the optical fiber cable 21 and a termination device 23 connected to the other end of the optical fiber cable 21. The termination device 23 is a device that performs termination processing of suppressing reflection of a sensing signal output from the sensing device 22.

The sensing device 22 outputs a pulse wave sensing signal to the optical fiber cable 21. Then, the sensing device 22 measures reflected signals (return light) for sensing signals from all positions of the optical fiber cable 21 in time series. Note that, in the optical fiber cable 21, the light intensity of the return light changes when vibration or sound is applied and when the temperature changes. The sensing device 22 calculates the position to which vibration or sound is applied in the optical fiber cable 21 on the basis of the round-trip time from the output of the sensing signal to the observation of the return light in which the light intensity has changed.

The sensing device 22 simultaneously measures application of vibration and sound at a plurality of points at predetermined distance (for example, 1 m) intervals. In addition, by outputting the sensing signal at a time interval at which the return light from the farthest end of the optical fiber cable 21 and the light of the sensing signal to be output next are not mixed, it is possible to measure a change (temporal transition) of vibration or sound applied at each position over time. In addition, the optical fiber cable 21 may be laid at different heights at each point. As a result, the three-dimensional position of the place where an abnormality has occurred can be estimated.

By using the optical fiber sensor 20, for example, laying work is facilitated as compared with a case of using a plurality of microphones or a plurality of vibration sensors. In addition, in a case where the optical fiber cable 21 for communication has already been laid, the optical fiber cable 21 can be shared between for communication and for maintenance of equipment, so that new laying work is unnecessary. In addition, since electricity does not flow through the optical fiber cable 21, the optical fiber cable 21 can be used in a facility where there is a possibility that a combustible gas exists. Note that, in the inspection system 1 according to the example embodiment, at least one of a plurality of microphones or a plurality of vibration sensors may be used instead of or in addition to the optical fiber sensor 20.

The inspection apparatus 30 is an apparatus including a sensor for inspecting various facilities such as a substation, a power plant, a factory, and a chemical plant. The inspection apparatus 30 may have a function of performing inspection while autonomously moving around the facility. In this case, the inspection apparatus 30 may be, for example, an autonomously mobile robot that moves on the ground by wheels or legs. In addition, the inspection apparatus 30 may also be, for example, a drone (unmanned aerial vehicle) that moves by flight, a balloon, or the like.

### <Hardware Configuration>

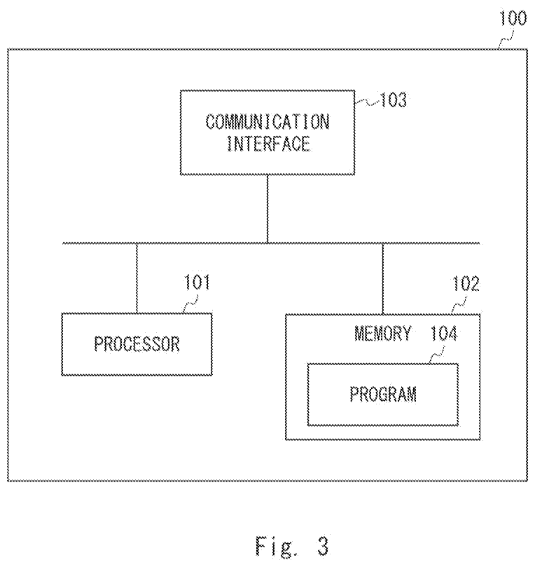

FIG. 3 is a diagram illustrating a hardware configuration example of the information processing apparatus 10 according to the example embodiment. In the example of FIG. 3, the information processing apparatus 10 (a computer 100) includes the processor 101, the memory 102, and a communication interface 103. These units may be connected by a bus or the like. The memory 102 stores at least a part of a program 104. The communication interface 103 includes an interface necessary for communication with other network elements.

When the program 104 is executed by the processor 101, the memory 102, and the like in cooperation with each other, at least a part of the processing according to the example embodiment of the present disclosure is executed by the computer 100. The memory 102 may be of any type suitable for a local technology network. The memory 102 may be a non-transitory computer-readable storage medium, as a non-limiting example. In addition, the memory 102 may also be implemented using any suitable data storage technology, such as semiconductor-based memory devices, magnetic memory devices and systems, optical memory devices and systems, fixed memory and removable memory, and the like. Although only one memory 102 is illustrated in the computer 100, there may be several physically different memory modules in the computer 100. The processor 101 may be of any type. The processor 101 may include one or more of a general purpose computer, a special purpose computer, a microprocessor, a digital signal processor (DSP), and a processor based on a multi-core processor architecture as a non-limiting example. The computer 100 may include a plurality of processors such as application specific integrated circuit chips that are temporally dependent on a clock that synchronizes the main processor.

The example embodiments of the present disclosure may be implemented in hardware or dedicated circuitry, software, logic, or any combination thereof. Some aspects may be implemented in hardware, while other aspects may be implemented in firmware or software that may be executed by a controller, a microprocessor or other computing devices.

The present disclosure also provides at least one computer program product tangibly stored on a non-transitory computer-readable storage medium. The computer program product includes computer-executable instructions, such as those included in a program module, and executes on a device on the subject real or virtual processor to perform the processes or methods of the present disclosure. The program modules include routines, programs, libraries, objects, classes, components, data structures, and the like that execute particular tasks or implement particular abstract data types. The functionality of the program modules may be combined or divided between the program modules as desired in various example embodiments. The machine-executable instructions of the program module can be executed in a local or distributed device. In a distributed device, the program modules can be located on both local and remote storage media.

Program code for executing the methods of the present disclosure may be written in any combination of one or more programming languages. These program codes are provided to a processor or controller of a general purpose computer, dedicated computer, or other programmable data processing apparatus. When the program code is executed by a processor or controller, the functions/operations in the flowcharts and/or the implementing block diagrams are performed. The program code executes entirely on the machine, partly on the machine, as a stand-alone software package, partly on the machine, partly on a remote machine, or entirely on the remote machine or server.

The program can be stored and supplied to the computer using various types of non-transitory computer readable media. The non-transitory computer readable media include various types of tangible storage media. Examples of the non-transitory computer readable medium include a magnetic recording medium, a magneto-optical recording medium, an optical disc medium, and a semiconductor memory. Examples of the magnetic recording medium include a flexible disk, a magnetic tape, and a hard disk drive. Examples of the magneto-optical recording medium include a magneto-optical disk. Examples of the optical disc medium include a Blu-ray disc, a compact disc (CD)-read only memory (ROM), a CD-recordable (R), and a CD-rewritable (RW). Examples of the semiconductor memory include a solid state drive, a mask ROM, a programmable ROM (PROM), an erasable PROM (EPROM), a flash ROM, and a random access memory (RAM). In addition, the program may be supplied to the computer using various types of transitory computer readable media. Examples of the transitory computer readable media include electrical signals, optical signals, and electromagnetic waves. The transitory computer readable media can supply the programs to the computer via a wired communication path such as an electric wire and an optical fiber or a wireless communication path.

### <Processing>

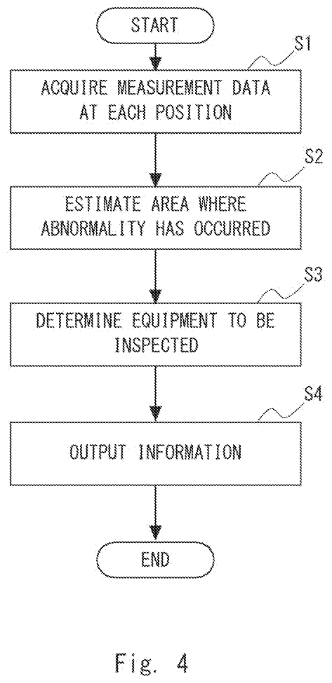

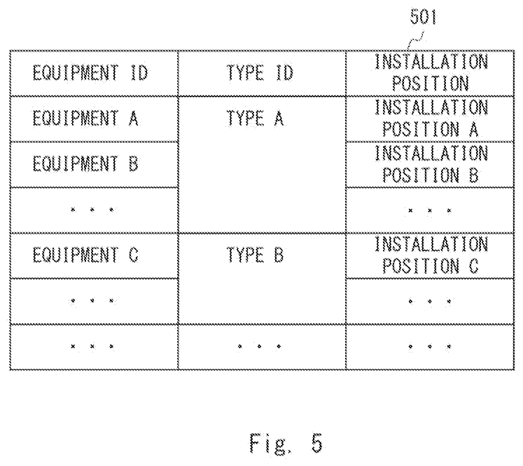

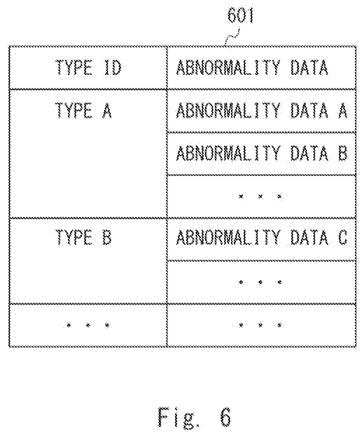

Next, an example of processing of the information processing apparatus 10 according to the example embodiment will be described with reference to FIGS. 4 to 6. FIG. 4 is a flowchart illustrating an example of the processing of the information processing apparatus 10 according to the example embodiment. FIG. 5 is a diagram illustrating an example of an equipment DB 501 according to the example embodiment. FIG. 6 is a diagram illustrating an example of a type DB 601 according to the example embodiment.

In step S1, the acquisition unit 11 of the information processing apparatus 10 acquires measurement data of transition of amplitude (intensity) of vibration or sound measured at each predetermined position of the optical fiber cable 21 and information indicating each predetermined position from the optical fiber sensor 20. The information indicating each predetermined position may include, for example, information regarding the latitude, longitude, and height of each predetermined position. Note that the information indicating each predetermined position may be registered in advance in the sensing device 22, for example.

Subsequently, the control unit 12 of the information processing apparatus 10 estimates an area where an abnormality has occurred on the basis of the data acquired by the acquisition unit 11 (step S2). Here, the information processing apparatus 10 may first determine whether or not the transition of vibration or sound measured by the optical fiber sensor 20 is abnormal using, for example, artificial intelligence (AI) or the like.

Then, in a case where it is determined that the transition is abnormal, the information processing apparatus 10 may calculate, for example, a difference in time during which vibration or sound has propagated from a generation source of vibration or sound to each predetermined position of the optical fiber cable 21 (arrival time difference). Then, the information processing apparatus 10 may calculate a difference in distance from each predetermined position to the generation source on the basis of each of the calculated time differences of arrival. Then, for example, the information processing apparatus 10 may estimate a two-dimensional or three-dimensional area where the generation source is located on the basis of the difference between the calculated distances.

Subsequently, the control unit 12 of the information processing apparatus 10 refers to the equipment data base (DB) 501 and the type DB 601, and determines equipment to be inspected on the basis of the measurement data acquired by the acquisition unit 11 among each piece of equipment installed in the estimated area (step S3). As a result, for example, the equipment in which an abnormality has occurred can be appropriately specified.

In the example of FIG. 5, in the equipment DB 501, a type ID and information regarding an installation position are recorded (registered) in advance by an administrator (operator) or the like in association with an equipment ID. Note that the equipment DB 501 may be recorded in a recording device inside the information processing apparatus 10 or may be recorded in a DB server or the like outside the information processing apparatus 10. The equipment ID is identification information of equipment (device). The type ID is identification information of a type (model) of the equipment. The installation position is information indicating a position where the equipment is installed. The installation position may include, for example, information regarding the latitude, longitude, and height.

In the example of FIG. 6, in the type DB 601, one or more pieces of abnormality data are recorded (registered) in advance by an administrator (operator) or the like in association with the type ID. Note that the type DB 601 may be recorded in a recording device inside the information processing apparatus 10 or may be recorded in a DB server or the like outside the information processing apparatus 10. The abnormality data may be, for example, waveform data indicating transition of vibration or sound measured by the optical fiber sensor 20 or the like when an abnormality occurred in the past in the equipment of the type related to the type ID.

The information processing apparatus 10 may first extract, from the equipment DB 501, each equipment ID installed in an area where the generation source of abnormal vibration or sound is estimated to be located. Then, the information processing apparatus 10 may extract, from the type DB 601, each piece of abnormality data associated with the type ID of each extracted equipment ID.

Then, the information processing apparatus 10 may calculate the similarity between the waveform of the measurement data measured by the optical fiber sensor 20 and the waveform of each extracted abnormality data. Here, the information processing apparatus 10 may calculate the similarity using measurement data of a point at which the maximum value of the amplitude is the largest among the measurement data of each point measured by the optical fiber sensor 20. In addition, the information processing apparatus 10 may calculate, for example, a correlation coefficient or the like between the waveform of the measurement data and the waveform of the abnormality data as the similarity.

Then, the information processing apparatus 10 may determine each piece of equipment with a type in which the calculated similarity is equal to or greater than a threshold as equipment to be inspected (inspected). In addition, the information processing apparatus 10 may determine each piece of equipment with a type in which the calculated similarity is highest as equipment to be inspected (inspected).

Subsequently, the output unit 13 of the information processing apparatus 10 outputs information based on equipment to be inspected determined by the control unit 12 (step S4). Here, for example, the information processing apparatus 10 may transmit a command for instructing the inspection of the determined equipment to be inspected to the inspection apparatus 30, which autonomously moves. In this case, the command may include, for example, information such as an installation place of the equipment to be inspected.

Then, the inspection apparatus 30 including the autonomous traveling robot, the unmanned aerial vehicle, or the balloon may autonomously move to the installation place of the instructed equipment to be inspected and transmit an image or the like of the periphery of the equipment to be inspected captured by the camera to the monitoring center or the like.

### Modified Example

The information processing apparatus 10 may be an apparatus included in one housing, but the information processing apparatus 10 of the present disclosure is not limited thereto. Each unit of the information processing apparatus 10 may be implemented by, for example, cloud computing including one or more computers. In addition, at least a part of the processing of the information processing apparatus 10 may be realized by, for example, the inspection apparatus 30. In addition, the information processing apparatus 10 may be incorporated in a housing of the inspection apparatus 30, for example. Such an information processing apparatus 10 is also included in an example of the “information processing apparatus” of the present disclosure.

Note that the present disclosure is not limited to the above-described example embodiments, and can be appropriately modified without departing from the gist.

Some or all of the above-described example embodiments can be described as in the following Supplementary Notes, but are not limited to the following Supplementary Notes.

### (Supplementary Note 1)

An information processing apparatus including:
acquisition means for acquiring information indicating a first point, information indicating a second point, first measurement data measured at the first point, and second measurement data measured at the second point;
control means for determining equipment to be inspected on the basis of the data acquired by the acquisition means; and
output means for outputting information based on the equipment determined by the control means.

### (Supplementary Note 2)

The information processing apparatus according to Supplementary Note 1, in which
the acquisition means acquires the first measurement data and the second measurement data measured by an optical fiber sensor, and
the first measurement data and the second measurement data include measurement data of at least one of sound or vibration.

### (Supplementary Note 3)

The information processing apparatus according to Supplementary Note 1 or 2,
in which the control means determines equipment to be inspected on the basis of similarity between data registered according to a model of each piece of equipment and data based on at least one of the first measurement data or the second measurement data.

### (Supplementary Note 4)

The information processing apparatus according to at least one of Supplementary Notes 1 to 3, in which
the control means
estimates an area where an abnormality has occurred on the basis of the data acquired by the acquisition means; and
determines equipment to be inspected, among each piece of equipment installed in the estimated area, on the basis of at least one of the first measurement data or the second measurement data.

### (Supplementary Note 5)

The information processing apparatus according to Supplementary Note 4, in which
the information indicating the first point includes information indicating a height of the first point,
the information indicating the second point includes information indicating a height of the second point, and
the control means estimates a three-dimensional area where an abnormality has occurred on the basis of the data acquired by the acquisition means.

### (Supplementary Note 6)

The information processing apparatus according to any one of Supplementary Notes 1 to 5,
in which the output means transmits a command for instructing an inspection of the equipment determined by the control means to an inspection apparatus that autonomously moves.

### (Supplementary Note 7)

An information processing method including:
acquiring information indicating a first point, information indicating a second point, first measurement data measured at the first point, and second measurement data measured at the second point;
determining equipment to be inspected on the basis of the acquired data; and
outputting information based on the determined equipment.

### (Supplementary Note 8)

A non-transitory computer readable medium storing a program for causing a computer to execute processing, the processing including:
acquiring information indicating a first point, information indicating a second point, first measurement data measured at the first point, and second measurement data measured at the second point;
determining equipment to be inspected on the basis of the acquired data; and
outputting information based on the determined equipment.

### (Supplementary Note 9)

An inspection system including:
an optical fiber sensor;
an information processing apparatus; and
an inspection apparatus configured to autonomously move, in which
the information processing apparatus includes:
acquisition means for acquiring information indicating a first point, information indicating a second point, first measurement data measured at the first point by the optical fiber sensor, and second measurement data measured at the second point;
control means for determining equipment to be inspected on the basis of the data acquired by the acquisition means; and
output means for transmitting a command for instructing an inspection of the equipment determined by the control means to the inspection apparatus that autonomously moves.

### REFERENCE SIGNS LIST

1 INSPECTION SYSTEM
10 INFORMATION PROCESSING APPARATUS
11 ACQUISITION UNIT
12 CONTROL UNIT
13 OUTPUT UNIT
20 OPTICAL FIBER SENSOR
21 OPTICAL FIBER CABLE
22 SENSING DEVICE
23 TERMINATION DEVICE
30 INSPECTION APPARATUS

What is claimed is:

1. An information processing apparatus comprising:
at least one memory storing instructions, and
at least one processor configured to execute the instructions to:
acquire information indicating a first point, information indicating a second point, first measurement data measured at the first point, and second measurement data measured at the second point;
determine equipment to be inspected on a basis of the data acquired by the acquisition means; and
output information based on the determined equipment.

2. The information processing apparatus according to claim 1, wherein
the at least one processor is configured to acquire the first measurement data and the second measurement data measured by an optical fiber sensor, and
the first measurement data and the second measurement data include measurement data of at least one of sound or vibration.

3. The information processing apparatus according to claim 1,
wherein the at least one processor is configured to determine equipment to be inspected on a basis of similarity between data registered according to a model of each piece of equipment and data based on at least one of the first measurement data or the second measurement data.

4. The information processing apparatus according to claim 1, wherein
the at least one processor is configured to;
estimate an area where an abnormality has occurred on a basis of the acquired data; and
determine equipment to be inspected, among each piece of equipment installed in the estimated area, on a basis of at least one of the first measurement data or the second measurement data.

5. The information processing apparatus according to claim 4, wherein
the information indicating the first point includes information indicating a height of the first point,
the information indicating the second point includes information indicating a height of the second point, and
the at least one processor is configured to estimate a three-dimensional area where an abnormality has occurred on a basis of the acquired data.

6. The information processing apparatus according to claim 1,
wherein the at least one processor is configured to transmit a command for instructing an inspection of the determined equipment to an inspection apparatus that autonomously moves.

7. An information processing method comprising:
acquiring information indicating a first point, information indicating a second point, first measurement data measured at the first point, and second measurement data measured at the second point;
determining equipment to be inspected on a basis of the acquired data; and
outputting information based on the determined equipment.

8. A non-transitory computer readable medium storing a program for causing a computer to execute processing, the processing comprising:
acquiring information indicating a first point, information indicating a second point, first measurement data measured at the first point, and second measurement data measured at the second point;
determining equipment to be inspected on a basis of the acquired data; and
outputting information based on the determined equipment.

9. (canceled)
